(19) United States
(12) Patent Application Publication
(10) Pub. No.: US 2025/0391103 A1
(43) Pub. Date: Dec. 25, 2025

(54) SHADOW MAP REPROJECTION

(71) Applicant: Tencent Technology (Shenzhen) Company Limited, Shenzhen (CN)

(72) Inventors: Chu WANG, Shenzhen (CN); Yazhen YUAN, Shenzhen (CN)

(73) Assignee: Tencent Technology (Shenzhen) Company Limited, Shenzhen (CN)

(21) Appl. No.: 19/317,100

(22) Filed: Sep. 2, 2025

Related U.S. Application Data
(63) Continuation of application No. PCT/CN2024/096784, filed on May 31, 2024.

(30) Foreign Application Priority Data
Jun. 14, 2023 (CN) 202310703131.5

(51) Int. Cl. G06T 15/60; G06T 7/73; G06T 15/04

(52) U.S. Cl. CPC G06T 15/60; G06T 7/75; G06T 15/04; G06T 2215/12

(57) ABSTRACT

In an image processing method, an i^{th}-frame cascaded shadow map is obtained to render an i^{th} image frame, i being a positive integer. For each of M shadow map layers of the i^{th}-frame cascaded shadow map, a first reprojection is performed to generate M first maps. Each first map corresponds to a respective shadow map layer of the M shadow map layers, M being a positive integer. Depth buffer data for each pixel of an (i+1)^{th} image frame is obtained. For each pixel of the (i+1)^{th} image frame, a second reprojection is performed based on the depth buffer data to generate M second maps respectively corresponding to the M shadow map layers. The M shadow map layers are updated based on the M first maps and the M second maps to obtain an (i+1)^{th}-frame cascaded shadow map to render the (i+1)^{th} image frame.

### RELATED APPLICATIONS

The present application is a continuation of International Application No. PCT/CN2024/096784, filed on May 31, 2024, which claims priority to Chinese Patent Application No. 202310703131.5, filed on Jun. 14, 2023. The entire disclosures of the prior applications are hereby incorporated by reference.

### FIELD OF THE TECHNOLOGY

This application relates to the field of computer technologies, including image processing.

### BACKGROUND OF THE DISCLOSURE

With the advancement of science and technology research, an image rendering technology has developed rapidly. In the image rendering technology, a target scene may be restored by rendering pixels in an image. For example, in a process of presenting a picture frame, pixels in the picture frame may be rendered by using a cascade shadow map corresponding to the picture frame, to obtain a rendered picture frame (that is, a picture frame for presentation). It is found in practice that when a target scenario is complex (for example, a shadow exists in the target scenario), a large quantity of computing resources needs to be consumed for updating a cascade shadow map.

### SUMMARY

Aspects of this disclosure include an image processing method, an apparatus, and a non-transitory computer-readable storage medium, which can reduce computing resources required for updating a cascade shadow map. Examples of technical solutions of this disclosure may be implemented as follows:

An aspect of this disclosure provides an image processing method. An i^{th}-frame cascaded shadow map is obtained to render an i^{th} image frame, i being a positive integer. For each of M shadow map layers of the i^{th}-frame cascaded shadow map, a first reprojection is performed to generate M first maps. Each first map corresponds to a respective shadow map layer of the M shadow map layers, M being a positive integer. Depth buffer data for each pixel of an (i+1)^{th} image frame is obtained. For each pixel of the (i+1)^{th} image frame, a second reprojection is performed based on the depth buffer data to generate M second maps respectively corresponding to the M shadow map layers. The M shadow map layers are updated based on the M first maps and the M second maps to obtain an (i+1)^{th}-frame cascaded shadow map to render the (i+1)^{th} image frame.

An aspect of this disclosure provides an image processing apparatus. The apparatus includes processing circuitry configured to obtain an i^{th}-frame cascaded shadow map to render an i^{th} image frame, i being a positive integer. For each of M shadow map layers of the i^{th}-frame cascaded shadow map, the processing circuitry is configured to perform a first reprojection to generate M first maps. Each first map corresponds to a respective shadow map layer of the M shadow map layers, M being a positive integer. The processing circuitry is configured to obtain depth buffer data for each pixel of an (i+1)^{th} image frame. For each pixel of the (i+1)^{th} image frame, the processing circuitry is configured to perform a second reprojection based on the depth buffer data to generate M second maps respectively corresponding to the M shadow map layers. The processing circuitry is configured to update the M shadow map layers based on the M first maps and the M second maps to obtain an (i+1)^{th}-frame cascaded shadow map to render the (i+1)^{th} image frame.

An aspect of this disclosure provides an image processing method, including: obtaining an i^{th}-frame cascade shadow map, the i^{th}-frame cascade shadow map being configured for rendering an i^{th} picture frame, and i being a positive integer; performing re-projection processing on M shadow maps of the i^{th}-frame cascade shadow map, to obtain M first maps, M being a positive integer; obtaining depth buffer information of each pixel in an (i+1)^{th} picture frame, and performing second re-projection processing on the pixel in the (i+1)^{th} picture frame based on the depth buffer information, to obtain M second maps; and updating the M shadow maps based on the M first maps and the M second maps, to obtain an (i+1)^{th}-frame cascade shadow map, the (i+1)^{th}-frame cascade shadow map being configured for rendering the (i+1)^{th} picture frame.

An aspect of this disclosure provides an image processing apparatus. The image processing apparatus includes: an obtaining unit, configured to obtain an i^{th}-frame cascade shadow map, the i^{th}-frame cascade shadow map being configured for rendering an i^{th} picture frame, and i being a positive integer; and a processing unit, configured to perform re-projection processing on M shadow maps of the i^{th}-frame cascade shadow map, to obtain M first maps, M being a positive integer, the obtaining unit being further configured to obtain depth buffer information of each pixel in an (i+1)^{th} picture frame; and the processing unit being further configured to: perform second re-projection processing on the pixel in the (i+1)^{th} picture frame based on the depth buffer information, to obtain M second maps; and update the M shadow maps based on the M first maps and the M second maps, to obtain an (i+1)^{th}-frame cascade shadow map; and the (i+1)^{th}-frame cascade shadow map being configured for rendering the (i+1)^{th} picture frame.

An aspect of this disclosure provides a computer device. The computer device includes: a memory, having a computer program stored therein; and a processor, configured to load the computer program to implement the foregoing image processing method.

An aspect of this disclosure provides a non-transitory computer-readable storage medium, having computer-executable instructions stored therein, the computer-executable instructions, when executed by a processor, cause the processor to implement the image processing method provided in the aspects of this disclosure.

An aspect of this disclosure provides a computer program product including a computer program. When the computer program product is run on a computer, the computer is enabled to perform the method according to the foregoing aspects.

According to an aspect of this disclosure, an i^{th}-frame cascade shadow map is obtained; first re-projection processing is performed on M shadow maps of the i^{th}-frame cascade shadow map, to obtain M first maps; depth buffer information of each pixel in an (i+1)^{th} picture frame is obtained, and second re-projection processing is performed on the pixel in the (i+1)^{th} picture frame based on the depth buffer information, to obtain M second maps; and the M shadow maps are updated based on the M first maps and the M second maps, to obtain an (i+1)^{th}-frame cascade shadow map. In view of the above, the M shadow maps are updated based on a re-projection result of the M shadow maps of the i^{th}-frame cascade shadow map and a re-projection result of the pixels in the (i+1)^{th} picture frame, to obtain the (i+1)^{th}-frame cascade shadow map, thereby reducing computing resources required for updating a cascade shadow map. In this way, a better shadow rendering effect can be obtained, especially in a scenario in which light sources change in a picture frame.

### BRIEF DESCRIPTION OF THE DRAWINGS

FIG. 1 is a diagram of an image processing scenario according to an aspect of this disclosure.

FIG. 2 is a flowchart of an image processing method according to an aspect of this disclosure.

FIG. 3 is a flowchart of another image processing method according to an aspect of this disclosure.

FIG. 4a is a schematic diagram of a spatial position conversion relationship according to an aspect of this disclosure.

FIG. 4b is a schematic diagram of neighboring pixels of a target pixel according to an aspect of this disclosure.

FIG. 4c is another schematic diagram of neighboring pixels of a target pixel according to an aspect of this disclosure.

FIG. 5 is a schematic structural diagram of an image processing apparatus according to an aspect of this disclosure.

FIG. 6 is a schematic structural diagram of a computer device according to an aspect of this disclosure.

### DETAILED DESCRIPTION

Technical solutions of aspects of this disclosure will be described below with reference to accompanying drawings of the aspects of this disclosure. The aspects described are merely some rather than all of the aspects of this disclosure. Based on the aspects of this disclosure, all other aspects obtained by persons of ordinary skill in the art shall fall within the scope of this disclosure.

This disclosure relates to technologies related to image rendering. The following briefly describes relevant terms involved. Further, the descriptions of the terms are provided as examples only and are not intended to limit the scope of the disclosure.

Shadow map: It is a depth map of a scene that is drawn at a position of a light source of the scene in an irradiation direction of the light source. The shadow map may be configured for rendering a shadow in the scene.

Cascade shadow map: It is a technology configured for drawing a shadow effect, a principle of the technology is to improve shadow precision in a rendered image of a scene by drawing one or more shadow maps at a camera perspective (that is, a current observation perspective) of the scene. For example, if a visual cone of a capture device associated with the camera perspective is divided into N space blocks based on a distance between the visual cone and the capture device, N shadow maps need to be drawn at the camera perspective, where each shadow map corresponds to a space block of the visual cone, and N is a positive integer.

For the foregoing image rendering technology, an aspect of this disclosure provides an image processing method, which can reduce computing resources required for updating a cascade shadow map. FIG. 1 is a diagram of an image processing scenario according to an aspect of this disclosure. As shown in FIG. 1, the image processing scenario provided in this disclosure includes a computer device 101. An image processing solution provided in this disclosure may be executed by the computer device 101. The computer device 101 may be a terminal device or a server. The terminal device may include, but is not limited to: a smartphone (such as an Android mobile phone or an IOS mobile phone), a tablet computer, a portable personal computer, a mobile internet device (MID for short), an in-vehicle terminal, a smart home appliance, a wearable device, or the like. This is not limited in the aspects of this disclosure. The server may be an independent physical server, or may be a server cluster or a distributed system that includes a plurality of physical servers, or may be a cloud server that provides basic cloud computing services such as a cloud service, a cloud database, cloud computing, a cloud function, cloud storage, a network service, cloud communication, a middleware service, a domain name service, a security service, a content delivery network (CDN), big data, and an artificial intelligence platform. This is not limited in the aspects of this disclosure.

The quantity of computer devices in FIG. 1 is merely used as an example, and does not constitute an actual limitation of this disclosure. For example, FIG. 1 may further include a computer device 102 (for example, configured to transmit an i^{th}-frame cascade shadow map to the computer device 101). The computer device 101 and the computer device 102 may be connected in a wired or wireless manner. This is not limited in this disclosure.

During specific implementation, a general principle of the image processing solution is as follows:

(1) The computer device 101 obtains an i^{th}-frame cascade shadow map, where the i^{th}-frame cascade shadow map is configured for rendering an i^{th} picture frame, and i is a positive integer. In an implementation, the computer device 101 divides, based on a scene depth corresponding to the i^{th} picture frame, a visual cone of a capture device corresponding to the i^{th} picture frame (a camera perspective) into N space blocks (each space block has a different depth range and the space blocks do not overlap with each other), where N is a positive integer; and generates a bounding box of each space block at a perspective of a light source of a scene. After obtaining the bounding box of each space block, the computer device 101 generates a shadow map of each space block based on the bounding box of the space block, and adds the shadow map of each space block to a map set, to obtain the i^{th}-frame cascade shadow map. In the foregoing aspect, the i^{th}-frame cascade shadow map includes N shadow maps.

(2) The computer device 101 performs first re-projection processing on M shadow maps of the i^{th}-frame cascade shadow map, to obtain M first maps, where M is a positive integer. Any shadow map in the i^{th}-frame cascade shadow map is represented as a j^{th} shadow map of the i^{th}-frame cascade shadow map. For the j^{th} shadow map of the i^{th}-frame cascade shadow map, the first re-projection processing is: converting a position (for example, a coordinate) of each pixel in the j^{th} shadow map of the i^{th}-frame cascade shadow map in shadow space (UV space) into a position in world space by using an inverse shadow projection matrix of the j^{th} shadow map of the i^{th}-frame cascade shadow map, and then converting a position of each pixel in the j^{th} shadow map of the i^{th}-frame cascade shadow map in the world space into a position in the shadow space by using a shadow projection matrix of an (i+1)^{th}-frame cascade shadow map, so as to update the position of each pixel in the j^{th} shadow map of the i^{th}-frame cascade shadow map in the shadow space. After an updated position of each pixel in the j^{th} shadow map of the i^{th}-frame cascade shadow map in the shadow space is obtained, a to-be-updated map is updated by using the updated position of each pixel in the j^{th} shadow map of the i^{th}-frame cascade shadow map in the shadow space, to obtain a first map corresponding to the j^{th} shadow map of the i^{th}-frame cascade shadow map. The to-be-updated map is the j^{th} shadow map of the i^{th}-frame cascade shadow map, or a preset shadow map (for example, a blank map in which depth values of pixels are all preset values).

(3) The computer device 101 obtains depth buffer information of an (i+1)^{th} picture frame, and performs second re-projection processing on a pixel in the (i+1)^{th} picture frame based on the depth buffer information of the (i+1)^{th} picture frame, to obtain M second maps. The depth buffer information of the (i+1)^{th} picture frame carries a depth value of each pixel in the (i+1)^{th} picture frame at the camera perspective (an observation perspective). The M first maps and the M second maps are in one-to-one correspondence, and the corresponding first maps and second maps are configured for updating the same shadow map in the M shadow maps of the i^{th}-frame cascade shadow map.

That the computer device 101 performs second re-projection processing on a pixel in the (i+1)^{th} picture frame based on the depth buffer information of the (i+1)^{th} picture frame means that the computer device 101 determines a position of each pixel in view space by using a position of the pixel in the (i+1)^{th} picture frame and a depth value of the pixel. Then, by using a view projection matrix (which may be configured for indicating a conversion (projection) relationship between the position of the pixel in the view space and the position of the pixel in the world space) of a capture device corresponding to the (i+1)^{th} picture frame (capture devices corresponding to different picture frames may be the same or different, and each capture device corresponds to a view projection matrix), a position of each pixel in the (i+1)^{th} picture frame in the view space (corresponding to the observation perspective of the (i+1)^{th} picture frame) is converted into a position in the world space. After converting the position of each pixel in the (i+1)^{th} picture frame in the view space into the position in the world space, the computer device 101 converts the position of each pixel in the (i+1)^{th} picture frame in the world space into a position in the shadow space by using the shadow projection matrix of the (i+1)^{th}-frame cascade shadow map. Then, the to-be-updated map is updated based on the position of each pixel in the (i+1)^{th} picture frame in the shadow space, to obtain a second map corresponding to the j^{th} shadow map of the i^{th}-frame cascade shadow map. The to-be-updated map is the j^{th} shadow map of the i^{th}-frame cascade shadow map, or a preset shadow map (for example, a blank map in which depth values of pixels are all preset values).

(4) The computer device updates the M shadow maps based on the M first maps and the M second maps, to obtain the (i+1)^{th}-frame cascade shadow map. The M first maps and the M second maps are in one-to-one correspondence. A j^{th} shadow map of the (i+1)^{th}-frame cascade shadow map is obtained by updating the j^{th} shadow map of the i^{th}-frame cascade shadow map based on the first map corresponding to the j^{th} shadow map of the i^{th}-frame cascade shadow map and the second map corresponding to the j^{th} shadow map of the i^{th}-frame cascade shadow map. The (i+1)^{th}-frame cascade shadow map is configured for rendering the (i+1)^{th} picture frame. In an implementation, the computer device 101 fuses each first map with a second map corresponding to the first map, to obtain M fusion maps; and filters the M fusion maps, to obtain M filtered fusion maps. After the M filtered fusion maps are obtained, the computer device 101 updates M shadow maps of the i^{th}-frame cascade shadow map by using the M filtered fusion maps, to obtain an updated (i+1)^{th}-frame cascade shadow map.

According to an aspect of this disclosure, an i^{th}-frame cascade shadow map is obtained; first re-projection processing is performed on M shadow maps of the i^{th}-frame cascade shadow map, to obtain M first maps; depth buffer information of each pixel in an (i+1)^{th} picture frame is obtained, and second re-projection processing is performed on the pixel in the (i+1)^{th} picture frame based on the depth buffer information, to obtain M second maps; and the M shadow maps are updated based on the M first maps and the M second maps, to obtain an (i+1)^{th}-frame cascade shadow map. In view of the above, the M shadow maps are updated based on a re-projection result of the M shadow maps of the i^{th}-frame cascade shadow map and a re-projection result of the depth buffer information of the (i+1)^{th} picture frame, to obtain the (i+1)^{th}-frame cascade shadow map, thereby reducing computing resources required for updating a cascade shadow map.

According to the foregoing image processing solution, the aspects of this disclosure provide a more detailed image processing method. The following describes, with reference to the accompanying drawings, the image processing method provided in the aspects of this disclosure in detail.

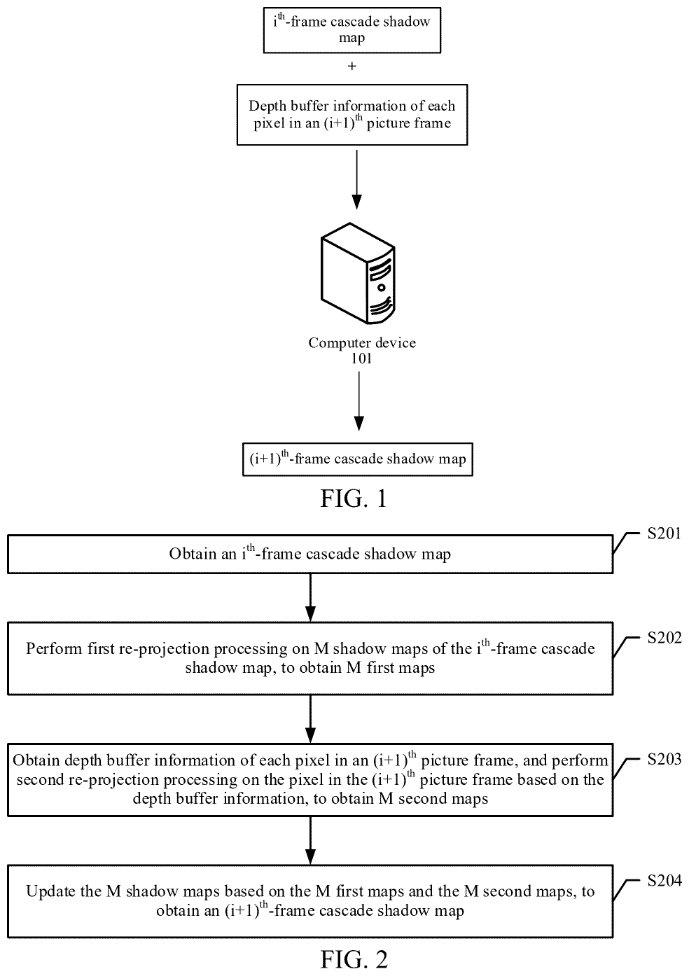

FIG. 2 is a flowchart of an image processing method according to an aspect of this disclosure. The image processing method may be executed by a computer device. The computer device may be a terminal device or a server. As shown in FIG. 2, the image processing method may include the following operations S201 to S204.

S201. Obtain an i^{th}-frame cascade shadow map. For example, an i^{th}-frame cascaded shadow map is obtained to render an i^{th} image frame, i being a positive integer.

The i^{th}-frame cascade shadow map is configured for rendering an i^{th} picture frame, where i is a positive integer. One picture frame corresponds to one frame of cascade shadow map. In an implementation, the computer device divides, based on a scene depth corresponding to the i^{th} picture frame, a visual cone of a capture device corresponding to the i^{th} picture frame (a camera perspective) into N space blocks (each space block has a different depth range and the space blocks do not overlap with each other), where N is a positive integer; and generates a bounding box of each space block at a perspective of a light source of a scene. After obtaining the bounding box of each space block, the computer device generates a shadow map of each space block based on the bounding box of the space block, and adds the shadow map of each space block to a map set, to obtain the i^{th}-frame cascade shadow map. Each shadow map carries a depth value of each pixel in the shadow map. A cascade shadow map is an image rendering technology configured for drawing a shadow effect. One or more shadow maps (a depth map of a scene that is drawn at a position of a light source of the scene in an irradiation direction of the light source) are drawn at the camera perspective (that is, a current observation perspective) of the scene, to improve shadow precision in a rendered image of the scene. That is, a cascade shadow map corresponding to each picture frame is composed of one or more shadow maps.

S202. Perform first re-projection processing on M shadow maps of the i^{th}-frame cascade shadow map, to obtain M first maps. For example, for each of M shadow map layers of the i^{th}-frame cascaded shadow map, a first reprojection is performed to generate M first maps. Each first map corresponds to a respective shadow map layer of the M shadow map layers, M being a positive integer.

A j^{th} shadow map of the i^{th}-frame cascade shadow map is any shadow map in the M shadow maps of the i^{th}-frame cascade shadow map; and j, M are both positive integers less than or equal to N, and N is a quantity of space blocks obtained by dividing a visual cone of a capture device corresponding to the i^{th} picture frame. For the j^{th} shadow map of the i^{th}-frame cascade shadow map, the first re-projection processing is: converting a position (for example, a coordinate) of each pixel in the j^{th} shadow map of the i^{th}-frame cascade shadow map in shadow space (UV space) into a position in world space by using an inverse shadow projection matrix of the j^{th} shadow map of the i^{th}-frame cascade shadow map, and then converting a position of each pixel in the j^{th} shadow map of the i^{th}-frame cascade shadow map in the world space into a position in the shadow space by using a shadow projection matrix of an (i+1)^{th}-frame cascade shadow map, so as to update the position of each pixel in the j^{th} shadow map of the i^{th}-frame cascade shadow map in the shadow space.

The shadow projection matrix and the inverse shadow projection matrix are configured for indicating a conversion relationship between a position of the same pixel in the shadow space and a position of the pixel in the world space. The inverse shadow projection matrix of the j^{th} shadow map of the i^{th}-frame cascade shadow map and a shadow projection matrix of the j^{th} shadow map of the i^{th}-frame cascade shadow map are inverse matrices of each other. For example, the shadow projection matrix of the j^{th} shadow map of the i^{th}-frame cascade shadow map is configured for projecting a pixel in the world space to the shadow space. The inverse shadow projection matrix of the j^{th} shadow map of the i^{th}-frame cascade shadow map is configured for projecting a pixel in the shadow space to the world space. Similarly, a shadow projection matrix of a j^{th} shadow map of the (i+1)^{th}-frame cascade shadow map is configured for projecting the pixel in the world space to the shadow space.

After an updated position of each pixel in the j^{th} shadow map of the i^{th}-frame cascade shadow map in the shadow space is obtained, a to-be-updated map is updated by using the updated position of each pixel in the j^{th} shadow map of the i^{th}-frame cascade shadow map in the shadow space, to obtain a first map corresponding to the j^{th} shadow map of the i^{th}-frame cascade shadow map. The to-be-updated map is the j^{th} shadow map of the i^{th}-frame cascade shadow map, or a preset shadow map (for example, a blank map in which depth values of pixels are all preset values).

After the position of each pixel in the j^{th} shadow map of the i^{th}-frame cascade shadow map is updated, these pixels are associated with the (i+1)^{th}-frame in terms of position. When the to-be-updated map is updated by using the updated position, a depth value of the to-be-updated map may be adjusted based on a depth value of each pixel in the i^{th} frame, to accurately reflect the depth value in the i^{th} frame into the first map. An update manner may include replacement of a depth value.

In an implementation, each shadow map carries a depth value of each pixel in the shadow map. A process in which the computer device performs first re-projection processing on M shadow maps of the i^{th}-frame cascade shadow map, to obtain M (M is a positive integer) first maps includes: obtaining the shadow projection matrix of the j^{th} shadow map of the (i+1)^{th}-frame cascade shadow map, and then determining a position of each pixel in the j^{th} shadow map of the i^{th}-frame cascade shadow map in the shadow space based on a depth value of each pixel in the j^{th} shadow map of the i^{th}-frame cascade shadow map.

Further, the computer device updates, by using the shadow projection matrix of the j^{th} shadow map of the (i+1)^{th}-frame cascade shadow map, the position of each pixel in the j^{th} shadow map of the i^{th}-frame cascade shadow map in the shadow space; and updates the to-be-updated map based on an updated position of each pixel in the j^{th} shadow map of the i^{th}-frame cascade shadow map in the shadow space, to obtain the first map corresponding to the j^{th} shadow map of the i^{th}-frame cascade shadow map. The to-be-updated map may be the j^{th} shadow map of the i^{th}-frame cascade shadow map, or may be an original map, or another preset map. A depth value of each pixel in the original map is a preset value (for example, 1, positive infinity, or the like).

Based on depth values of pixels carried in the shadow map, in the process of the first re-projection processing, a position of each to-be-processed pixel in the shadow space can be accurately grasped, thereby improving precision of the first map.

S203. Obtain depth buffer information of each pixel in an (i+1)^{th} picture frame, and perform second re-projection processing on the pixel in the (i+1)^{th} picture frame based on the depth buffer information, to obtain M second maps. For example, depth buffer data for each pixel of an (i+1)^{th} image frame is obtained. For each pixel of the (i+1)^{th} image frame, a second reprojection is performed based on the depth buffer data to generate M second maps respectively corresponding to the M shadow map layers.

The depth buffer information of the (i+1)^{th} picture frame carries (stores) a depth value of each pixel in the (i+1)^{th} picture frame at the camera perspective (the observation perspective). The M first maps and the M second maps are in one-to-one correspondence, and the corresponding first maps and second maps are configured for updating the same shadow map in the M shadow maps of the i^{th}-frame cascade shadow map. For example, assuming that a target first map is a first map corresponding to the j^{th} shadow map of the i^{th}-frame cascade shadow map, and a target second map is a second map corresponding to the j^{th} shadow map of the i^{th}-frame cascade shadow map, the target first map and the target second map correspond to each other, and the target first map and the target second map are both configured for updating a j^{th} shadow map of the M shadow maps of the i^{th}-frame cascade shadow map.

In an implementation, in one aspect, the computer device may determine a position (x, y, z) of each pixel in view space by using a position (x, y) of the pixel in the (i+1)^{th} picture frame and a depth value (z) of the pixel. In another aspect, the computer device obtains a view projection matrix (of a capture device) corresponding to the (i+1)^{th} picture frame, and the shadow projection matrix of the j^{th} shadow map of the (i+1)^{th}-frame cascade shadow map. Capture devices corresponding to different picture frames may be the same or different. Each capture device corresponds to a view projection matrix. The view projection matrix may be configured for indicating a conversion (projection) relationship between the position of the pixel in the view space and the position of the pixel in the world space. For example, assuming that a picture frame 1 corresponds to a capture device 1, a picture frame 2 corresponds to a capture device 2, the capture device 1 corresponds to a view projection matrix 1, and the capture device 2 corresponds to a view projection matrix 2, a view projection matrix corresponding to the picture frame 1 is the view projection matrix 1, and a view projection matrix corresponding to the picture frame 2 is the view projection matrix 2. The view projection matrix 1 may be configured for converting a position of a pixel in the picture frame 1 in the view space into a position of the pixel in the picture frame 1 in the world space. The view projection matrix 2 may be configured for converting a position of a pixel in the picture frame 2 in the view space into a position of the pixel in the picture frame 2 in the world space. The shadow projection matrix and the inverse shadow projection matrix are configured for indicating a conversion relationship between a position of the same pixel in the shadow space and a position of the pixel in the world space. The shadow projection matrix of the j^{th} shadow map of the (i+1)^{th}-frame cascade shadow map is configured for projecting the pixel in the world space to the shadow space.

Next, the computer device converts, by using the view projection matrix (of the capture device) corresponding to the (i+1)^{th} picture frame and the shadow projection matrix of the j^{th} shadow map of the (i+1)^{th}-frame cascade shadow map, a position of each pixel in the (i+1)^{th} picture frame in the view space into a position in the shadow space. Further, the computer device updates the to-be-updated map based on the position that is of each pixel in the (i+1)^{th} picture frame and that is in the shadow space, to obtain the second map corresponding to the j^{th} shadow map of the i^{th}-frame cascade shadow map. The to-be-updated map may be the j^{th} shadow map of the i^{th}-frame cascade shadow map, or may be an original map, or another preset map. A depth value of each pixel in the original map is a preset value (for example, 1, positive infinity, or the like).

The position in the view space is converted into the position the shadow space, and the to-be-updated map is updated based on a converted position, to obtain a second map. The second map may reflect a position of a shadow part in the (i+1)^{th} frame. The update is mainly updating a depth value of a pixel in the to-be-updated map, and the update manner may include replacement of the depth value.

S204. Update the M shadow maps based on the M first maps and the M second maps, to obtain the (i+1)^{th}-frame cascade shadow map. For example, the M shadow map layers are updated based on the M first maps and the M second maps to obtain an (i+1)^{th}-frame cascaded shadow map to render the (i+1)^{th} image frame.

The j^{th} shadow map of the (i+1)^{th}-frame cascade shadow map is obtained by updating the j^{th} shadow map of the i^{th}-frame cascade shadow map based on the first map corresponding to the j^{th} shadow map of the i^{th}-frame cascade shadow map and the second map corresponding to the j^{th} shadow map of the i^{th}-frame cascade shadow map. The (i+1)^{th}-frame cascade shadow map is configured for rendering the (i+1)^{th} picture frame.

In this operation, association between shadow parts in the i^{th} frame and the (i+1)^{th} frame can be effectively reflected by using the first map and the second map. When the M shadow maps are updated, a depth value of each pixel in the shadow maps is mainly updated. For example, by using a pixel as a unit, depth values in the shadow maps are replaced based on depth values in the first map and the second map.

In an implementation, the M first maps and the M second maps are in one-to-one correspondence. The computer device fuses each first map with a second map corresponding to the first map, to obtain M fusion maps; and filters the M fusion maps, to obtain M filtered fusion maps. After the M filtered fusion maps are obtained, the computer device updates M shadow maps of the i^{th}-frame cascade shadow map by using the M filtered fusion maps, to obtain an updated (i+1)^{th}-frame cascade shadow map.

In another aspect, the computer device updates the M shadow maps of the i^{th}-frame cascade shadow map by using the M first maps (the first map corresponding to the j^{th} shadow map of the i^{th}-frame cascade shadow map is configured for updating the j^{th} shadow map), to obtain a first update result of the M shadow maps of the i^{th}-frame cascade shadow map. The first update result of the M shadow maps of the i^{th}-frame cascade shadow map is further updated by using the M second maps (the second map corresponding to the j^{th} shadow map of the i^{th}-frame cascade shadow map is configured for updating a first update result of the j^{th} shadow map), to obtain a second update result of the M shadow maps of the i^{th}-frame cascade shadow map. After the second update result of the M shadow maps of the i^{th}-frame cascade shadow map is obtained, the second update result of the M shadow maps of the i^{th}-frame cascade shadow map is filtered, to obtain an updated (i+1)^{th}-frame cascade shadow map. An order of updating the shadow maps by using the first maps and the second maps may be reversed. This is not limited in this disclosure.

According to an aspect of this disclosure, an i^{th}-frame cascade shadow map is obtained; first re-projection processing is performed on M shadow maps of the i^{th}-frame cascade shadow map, to obtain M first maps; depth buffer information of each pixel in an (i+1)^{th} picture frame is obtained, and second re-projection processing is performed on the pixel in the (i+1)^{th} picture frame based on the depth buffer information, to obtain M second maps; and the M shadow maps are updated based on the M first maps and the M second maps, to obtain an (i+1)^{th}-frame cascade shadow map. In view of the above, the M shadow maps are updated based on a re-projection result of the M shadow maps of the i^{th}-frame cascade shadow map and a re-projection result of the depth buffer information of the (i+1)^{th} picture frame, to obtain the (i+1)^{th}-frame cascade shadow map, thereby reducing computing resources required for updating a cascade shadow map. Further, the (i+1)^{th} picture frame is rendered by using an updated (i+1)^{th}-frame cascade shadow map, to improve a rendering effect of the picture frame.

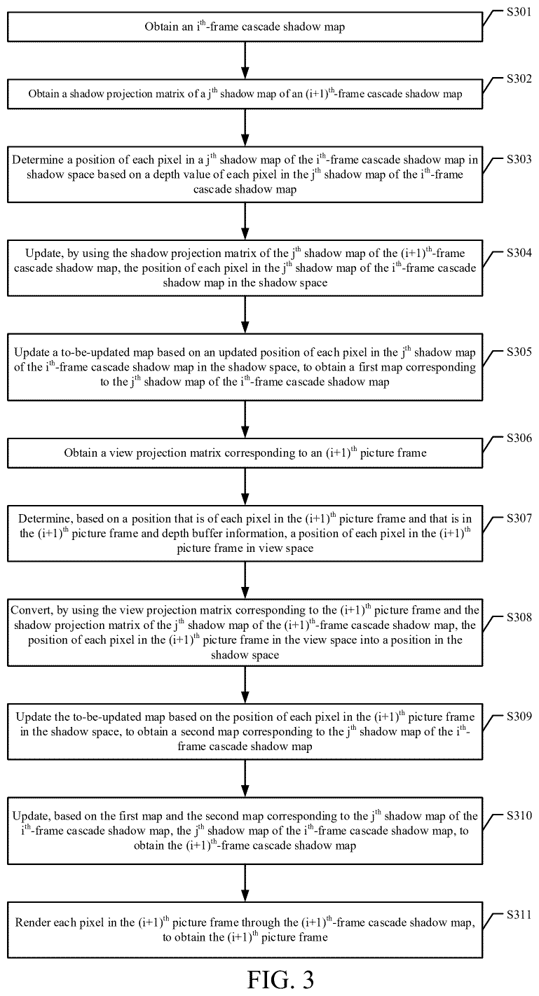

FIG. 3 is a flowchart of another image processing method according to an aspect of this disclosure. The image processing method may be executed by a computer device. The computer device may be a terminal device or a server. As shown in FIG. 3, the image processing method includes the following operations S301 to S311.

S301. Obtain an i^{th}-frame cascade shadow map. For example, an i^{th}-frame cascaded shadow map is obtained to render an i^{th} image frame. i is a positive integer.

For a specific aspect of operation S301, refer to the aspect of operation S201 in FIG. 2. Details are not described herein again.

S302. Obtain a shadow projection matrix of a j^{th} shadow map of an (i+1)^{th}-frame cascade shadow map. For example, a shadow projection matrix of a jth shadow map layer of the (i+1)^{th}-frame cascaded shadow map is obtained, j being an integer and 1≤j≤M;

The j^{th} shadow map of the (i+1)^{th}-frame cascade shadow map may be obtained by updating any one of M shadow maps of the i^{th}-frame cascade shadow map. For example, assuming that the i^{th}-frame cascade shadow map includes three shadow maps (for example, a shadow map 1 to a shadow map 3). If shadow maps in the i^{th}-frame cascade shadow map that need to be updated are the shadow map 1 and the shadow map 3 (that is, M=2), the j^{th} shadow map of the (i+1)^{th}-frame cascade shadow map may be obtained by updating the shadow map 1 of the i^{th}-frame cascade shadow map, or may be obtained by updating the shadow map 3 of the i^{th}-frame cascade shadow map.

In an implementation, the computer device obtains a view matrix (of a capture device) corresponding to an (i+1)^{th} picture frame and a projection matrix corresponding to a j^{th} level in the (i+1)^{th}-frame cascade shadow map, and performs product calculation on the view matrix and the projection matrix, to obtain a shadow projection matrix of a shadow map of the j^{th} level in the (i+1)^{th}-frame cascade shadow map. The view matrix (of the capture device) corresponding to the (i+1)^{th} picture frame is obtained based on a position and an orientation of a light source in a scene to which an object belongs at an (i+1)^{th} moment, and the (i+1)^{th} moment corresponds to the (i+1)^{th} picture frame. The projection matrix corresponding to the j^{th} level in the (i+1)^{th}-frame cascade shadow map is obtained based on a bounding box corresponding to the j^{th} level in the (i+1)^{th}-frame cascade shadow map.

S303. Determine a position of each pixel in a j^{th} shadow map of the i^{th}-frame cascade shadow map in shadow space based on a depth value of each pixel in the j^{th} shadow map of the i^{th}-frame cascade shadow map. For example, from the depth values, pixel positions of the pixels in a shadow space of the j^{th} shadow map layer of the i^{th}-frame cascaded shadow map are obtained.

The j^{th} shadow map of the i^{th}-frame cascade shadow map may be any one of the M shadow maps of the i^{th}-frame cascade shadow map. For example, assuming that the i^{th}-frame cascade shadow map includes three shadow maps (for example, the shadow map 1 to the shadow map 3), and the shadow maps needing to be updated are the shadow map 1 and the shadow map 3, the j^{th} shadow map of the i^{th}-frame cascade shadow map may be the shadow map 1 or the shadow map 3.

In an implementation, the computer device determines a position (which may be indicated by three-dimensional space coordinates (x, y, z)) of each pixel in the j^{th} shadow map of the i^{th}-frame cascade shadow map in the shadow space based on a position of each pixel in the j^{th} shadow map of the i^{th}-frame cascade shadow map in the shadow map (for determining x-axis and y-axis coordinates of each pixel in view space), and a depth value of each pixel in the j^{th} shadow map of the i^{th}-frame cascade shadow map (for determining a z-axis coordinate of each pixel in the view space).

S304. Update, by using the shadow projection matrix of the j^{th} shadow map of the (i+1)^{th}-frame cascade shadow map, the position of each pixel in the j^{th} shadow map of the i^{th}-frame cascade shadow map in the shadow space. For example, the pixel positions in the shadow space are updated based on the shadow projection matrix.

Each shadow map carries a depth value of each pixel in the shadow map. In an implementation, the computer device obtains an inverse shadow projection matrix of the j^{th} shadow map of the i^{th}-frame cascade shadow map (the inverse shadow projection matrix may be obtained by using a shadow projection matrix of the j^{th} shadow map of the i^{th}-frame cascade shadow map). The computer device performs, by using the inverse shadow projection matrix of the j^{th} shadow map of the i^{th}-frame cascade shadow map, first conversion (projection) on the position of each pixel in the j^{th} shadow map in the i^{th}-frame cascade shadow map in the shadow space, to obtain a position of each pixel in the j^{th} shadow map of the i^{th}-frame cascade shadow map in world space. That is, the first conversion refers to converting, by using the inverse shadow projection matrix, the position of the pixel in the shadow space into the position of the pixel in the world space.

The foregoing aspect may also be understood as that, the computer device determines, by using the inverse shadow projection matrix of the j^{th} shadow map of the i^{th}-frame cascade shadow map, a conversion relationship between a position of each pixel in the j^{th} shadow map of the i^{th}-frame cascade shadow map in the shadow space and a position of the pixel in the world space, thereby converting the position of each pixel in the j^{th} shadow map of the i^{th}-frame cascade shadow map in the shadow space based on the conversion relationship, to obtain the position of each pixel in the j^{th} shadow map of the i^{th}-frame cascade shadow map in the world space.

After the position of each pixel in the j^{th} shadow map of the i^{th}-frame cascade shadow map in the world space is obtained, the computer device performs, by using the shadow projection matrix of the j^{th} shadow map of the (i+1)^{th}-frame cascade shadow map, second conversion on the position of each pixel in the j^{th} shadow map of the i^{th}-frame cascade shadow map in the world space, to obtain an updated position of each pixel in the j^{th} shadow map of the i^{th}-frame cascade shadow map in the shadow space. That is, the second conversion refers to converting, by using the shadow projection matrix, the position of the pixel in the world space into the position of the pixel in the shadow space.

When the shadow projection matrix of the j^{th} shadow map of the i^{th}-frame cascade shadow map is different from the shadow projection matrix of the j^{th} shadow map of the (i+1)^{th}-frame cascade shadow map, a first conversion result and a second conversion result are different. The first conversion result is a position of a target pixel in the shadow space that is obtained by converting (projecting) a position of the target pixel in the world space based on the shadow projection matrix of the j^{th} shadow map of the i^{th}-frame cascade shadow map. The second conversion result is the position of the target pixel in the shadow space that is obtained by converting (projecting) the position of the target pixel in the world space based on the shadow projection matrix of the j^{th} shadow map of the (i+1)^{th}-frame cascade shadow map.

A shadow difference between adjacent cascade shadow maps may be effectively captured by using inverse shadow projection matrices and shadow projection matrices of the adjacent cascade shadow maps, thereby improving accuracy of subsequent generation of the (i+1)^{th}-frame cascade shadow map.

S305. Update a to-be-updated map based on the updated position of each pixel in the j^{th} shadow map of the i^{th}-frame cascade shadow map in the shadow space, to obtain a first map corresponding to the j^{th} shadow map of the i^{th}-frame cascade shadow map. For example, the j^{th} shadow map layer of the i^{th}-frame cascaded shadow map or a preset blank map with the updated pixel positions are updated to form the first map corresponding to the j^{th} shadow map layer.

The to-be-updated map may be the j^{th} shadow map of the i^{th}-frame cascade shadow map, or may be a preset shadow map (for example, a shadow map whose scale is the same as that of the j^{th} shadow map of the i^{th}-frame cascade shadow map and whose depth value of each pixel is positive infinity). The first map corresponding to the j^{th} shadow map of the i^{th}-frame cascade shadow map may be configured for updating the j^{th} shadow map of the i^{th}-frame cascade shadow map. If the to-be-updated map is the j^{th} shadow map of the i^{th}-frame cascade shadow map, the first map corresponding to the j^{th} shadow map of the i^{th}-frame cascade shadow map is a shadow map obtained by updating the j^{th} shadow map of the i^{th}-frame cascade shadow map.

In an implementation, a process in which the computer device updates a to-be-updated map based on the updated position of each pixel in the j^{th} shadow map of the i^{th}-frame cascade shadow map in the shadow space (for example, through an InterlockedMin operation), to obtain a first map corresponding to the j^{th} shadow map of the i^{th}-frame cascade shadow map includes: determining a map position and a depth update value of a k^{th} pixel in the j^{th} shadow map of the i^{th}-frame cascade shadow map based on an updated position of the k^{th} pixel in the shadow space. For example, the updated position of the k^{th} pixel in the j^{th} shadow map of the i^{th}-frame cascade shadow map in the shadow space may be indicated by using three-dimensional space coordinates (x, y, z), where (x, y) is configured for indicating the map position of the k^{th} pixel (in the shadow space), and z is configured for indicating the depth update value of the k^{th} pixel (in the shadow space). The to-be-updated map may be the j^{th} shadow map of the i^{th}-frame cascade shadow map, or may be an original map, or another preset map. A depth value of each pixel in the original map is a preset value (for example, 1, positive infinity, or the like).

If the depth value of the target pixel in the to-be-updated map is greater than the depth update value of the k^{th} pixel, the computer device updates the depth value of the target pixel to the depth update value of the k^{th} pixel. Correspondingly, if the depth value of the target pixel in the to-be-updated map is less than or equal to the depth update value of the k^{th} pixel, the computer device keeps the depth value of the target pixel unchanged. A position of the target pixel in the to-be-updated map matches the map position of the k^{th} pixel; and the k^{th} pixel in the j^{th} shadow map of the i^{th}-frame cascade shadow map is any pixel in the j^{th} shadow map of the i^{th}-frame cascade shadow map.

For example, assuming that in the j^{th} shadow map of the i^{th}-frame cascade shadow map, the k^{th} pixel has a map position of (x1, y1) and a depth value of z1 before the update, and the k^{th} pixel has a map position of (x2, y2) and a depth value of z2 after the update, a pixel located at (x2, y2) in the to-be-updated map is a target pixel, and a depth value of the target pixel is set to z3. If z2 is greater than or equal to z3, the depth value z3 of the target pixel is kept unchanged. If z2 is less than z3, the depth value of the target pixel is updated to z2. By comparing the depth value of the target pixel in the to-be-updated map with a depth value of a k^{th} pixel whose position matches a position of the target pixel in the j^{th} shadow map, a pixel belonging to a shadow part can be quickly determined in the to-be-updated map, thereby improving efficiency of generating the (i+1)^{th}-frame cascade shadow map.

S306. Obtain a view projection matrix corresponding to the (i+1)^{th} picture frame. For example, a view projection matrix for the (i+1)^{th} image frame and a shadow projection matrix of a j^{th} shadow map layer of the (i+1)^{th}-frame cascaded shadow map are obtained, j being an integer and 1≤j≤M.

The view projection matrix corresponding to the (i+1)^{th} picture frame refers to a view projection matrix (of the capture device) corresponding to the (i+1)^{th} picture frame. The view projection matrix (of the capture device) corresponding to the (i+1)^{th} picture frame is configured for converting a position of each pixel in the (i+1)^{th} picture frame in the view space (corresponding to an observation perspective of the (i+1)^{th} picture frame) into a position in the world space. That is, the view projection matrix is configured for indicating a conversion relationship between a position of the same pixel in the view space and a position of the pixel in the world space.

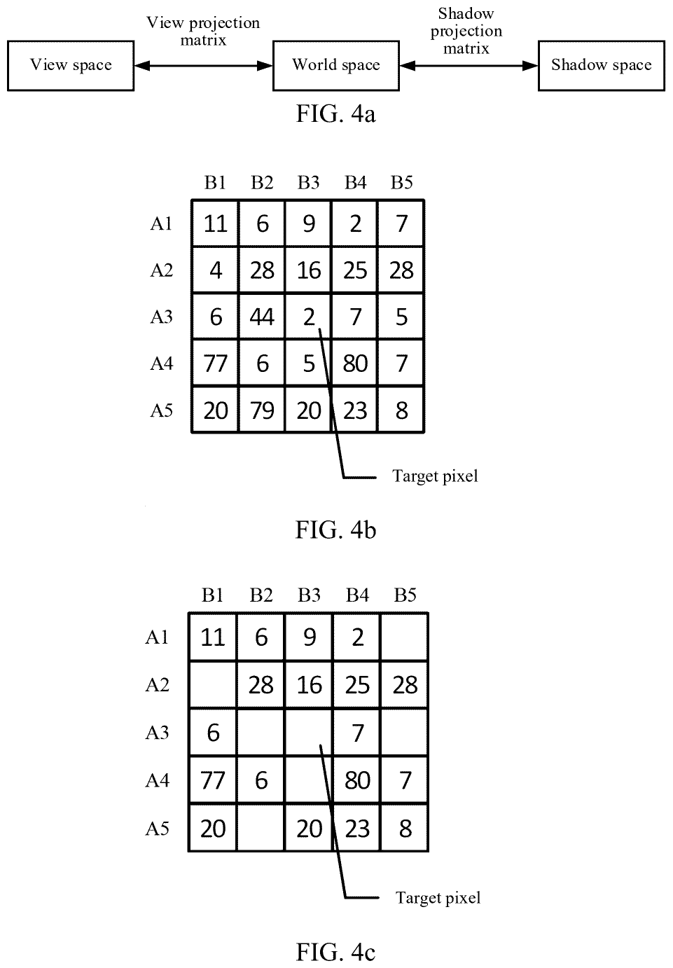

FIG. 4a is a schematic diagram of a spatial position conversion relationship according to an aspect of this disclosure. As shown in FIG. 4a, the position of the pixel in the view space may be converted into the position of the pixel in the world space through the view projection matrix. Correspondingly, the position of the pixel in the world space may be converted into the position of the pixel in the view space through an inverse matrix of the view projection matrix. In addition, the position of the pixel in the world space may be converted into the position of the pixel in the shadow space through the shadow projection matrix. Correspondingly, the position of the pixel in the shadow space may be converted into the position of the pixel in the world space through an inverse matrix of the shadow projection matrix (and the inverse shadow projection matrix). The position of the pixel in the view space may be obtained through a picture frame and depth buffer information of the picture frame. The position of the pixel in the shadow space may be obtained through a shadow map.

S307. Determine, based on a position that is of each pixel in the (i+1)^{th} picture frame and that is in the (i+1)^{th} picture frame and depth buffer information, a position of each pixel in the (i+1)^{th} picture frame in the view space. For example, pixel positions of the (i+1)^{th} image frame are converted based on the depth buffer data to obtain view space positions.

In an implementation, the computer device determines an x-axis coordinate and a y-axis coordinate of the k^{th} pixel based on a position (x, y) that is of the k^{th} pixel in the (i+1)^{th} picture frame and that is in the (i+1)^{th} picture frame. In addition, a z-axis coordinate (that is, a depth value) of the k^{th} pixel is determined by using depth buffer information of the (i+1)^{th} picture frame (carrying a depth value of each pixel in the (i+1)^{th} picture frame), to obtain a position (indicated by (x, y, z)) of the k^{th} pixel in the view space.

S308. Convert, by using the view projection matrix corresponding to the (i+1)^{th} picture frame and the shadow projection matrix of the j^{th} shadow map of the (i+1)^{th}-frame cascade shadow map, the position of each pixel in the (i+1)^{th} picture frame in the view space into a position in the shadow space. For example, the view space positions are converted to shadow space positions based on the view projection matrix and the shadow projection matrix.

In an implementation, the computer device performs, by using the view projection matrix, third conversion on the position of each pixel in the (i+1)^{th} picture frame in the view space, to obtain the position of each pixel in the (i+1)^{th} picture frame in the world space. That is, the third conversion refers to converting, by using the view projection matrix, the position of the pixel in the view space into the position of the pixel in the world space.

After the position of each pixel in the (i+1)^{th} picture frame in the world space is obtained, the computer device performs, by using the shadow projection matrix of the j^{th} shadow map of the (i+1)^{th}-frame cascade shadow map, the second conversion on the position of each pixel in the (i+1)^{th} picture frame in the world space, to obtain the position of each pixel in the (i+1)^{th} picture frame in the shadow space. The foregoing aspect may be understood as that, the view projection matrix determines a conversion relationship between the position of each pixel in the (i+1)^{th} picture frame in the view space and the position of the pixel in the world space, thereby converting the position of each pixel in the (i+1)^{th} picture frame in the view space based on the conversion relationship, to obtain the position of each pixel in the (i+1)^{th} picture frame in the world space.

S309. Update the to-be-updated map based on the position of each pixel in the (i+1)^{th} picture frame in the shadow space, to obtain a second map corresponding to the j^{th} shadow map of the i^{th}-frame cascade shadow map. For example, the j^{th} shadow map layer of the i^{th}-frame cascaded shadow map or a preset blank map with the shadow space positions are updated to form the second map corresponding to the j^{th} shadow map layer.

The to-be-updated map may be the j^{th} shadow map of the i^{th}-frame cascade shadow map, or may be a preset shadow map (for example, a shadow map obtained by updating the j^{th} shadow map of the i^{th}-frame cascade shadow map by using the first map corresponding to the j^{th} shadow map of the i^{th}-frame cascade shadow map). The second map corresponding to the j^{th} shadow map of the i^{th}-frame cascade shadow map may be configured for updating the j^{th} shadow map of the i^{th}-frame cascade shadow map. If the to-be-updated map is the j^{th} shadow map of the i^{th}-frame cascade shadow map, the second map corresponding to the j^{th} shadow map of the i^{th}-frame cascade shadow map is a shadow map obtained by updating the j^{th} shadow map of the i^{th}-frame cascade shadow map.

In an implementation, a process in which the computer device updates a to-be-updated map based on the position of each pixel in the (i+1)^{th} picture frame in the shadow space (for example, through an InterlockedMin operation), to obtain a second map corresponding to the j^{th} shadow map of the i^{th}-frame cascade shadow map includes: determining the map position and the depth value of the k^{th} pixel based on a position of the k^{th} pixel in the (i+1)^{th} picture frame in the shadow space. For example, a position of the k^{th} pixel in the j^{th} shadow map of the i^{th}-frame cascade shadow map in the shadow space may be indicated by using three-dimensional space coordinates (x, y, z), where (x, y) is configured for indicating the map position of the k^{th} pixel (in the shadow space), and z is configured for indicating the depth value of the k^{th} pixel (in the shadow space). The to-be-updated map may be the j^{th} shadow map of the i^{th}-frame cascade shadow map, or may be an original map, or another preset map. A depth value of each pixel in the original map is a preset value (for example, 1, positive infinity, or the like).

If the depth value of the target pixel in the to-be-updated map is greater than the depth update value of the k^{th} pixel, the computer device updates the depth value of the target pixel to the depth update value of the k^{th} pixel. Correspondingly, if the depth value of the target pixel in the to-be-updated map is less than or equal to the depth update value of the k^{th} pixel, the computer device keeps the depth value of the target pixel unchanged. The position of the target pixel in the to-be-updated map matches the map position of the k^{th} pixel, and the k^{th} pixel in the (i+1)^{th} picture frame is any pixel in the (i+1)^{th} picture frame.

For example, assuming that the map position of the k^{th} pixel (in the shadow space) in the (i+1)^{th} picture frame is (x1, y1), and the depth value is z1, a pixel located at (x1, y1) in the to-be-updated map is a target pixel, and a depth value of the target pixel is set to z2. If z1 is greater than or equal to z2, the depth value z2 of the target pixel is kept unchanged. If z1 is less than z2, the depth value of the target pixel is updated to z1.

By comparing the depth value of the target pixel in the to-be-updated map with a depth value of a k^{th} pixel whose position matches a position of the target pixel in the j^{th} shadow map, a pixel belonging to a shadow part can be quickly determined in the to-be-updated map, thereby improving efficiency of generating the (i+1)^{th}-frame cascade shadow map.

S310. Update, based on the first map and the second map corresponding to the j^{th} shadow map of the i^{th}-frame cascade shadow map, the j^{th} shadow map of the i^{th}-frame cascade shadow map, to obtain the (i+1)^{th}-frame cascade shadow map. For example, the M shadow map layers are updated based on the M first maps and the M second maps to obtain an (i+1)^{th}-frame cascaded shadow map to render the (i+1)^{th} image frame.

The j^{th} shadow map of the (i+1)^{th}-frame cascade shadow map is obtained by updating the j^{th} shadow map of the i^{th}-frame cascade shadow map based on the first map corresponding to the j^{th} shadow map of the i^{th}-frame cascade shadow map and the second map corresponding to the j^{th} shadow map of the i^{th}-frame cascade shadow map. The (i+1)^{th}-frame cascade shadow map is configured for rendering the (i+1)^{th} picture frame.

In an implementation, the computer device fuses the first map and the second map corresponding to the j^{th} shadow map of the i^{th}-frame cascade shadow map, to obtain a fusion map corresponding to the j^{th} shadow map of the i^{th}-frame cascade shadow map. For example, if any one of the first map and the second map corresponding to the j^{th} shadow map of the i^{th}-frame cascade shadow map includes a depth value of a k^{th} pixel in the fusion map corresponding to the j^{th} shadow map of the i^{th}-frame cascade shadow map, the computer device directly determines the depth value as the depth value of the k^{th} pixel in the fusion map corresponding to the j^{th} shadow map of the i^{th}-frame cascade shadow map. If both of the first map and the second map corresponding to the j^{th} shadow map of the i^{th}-frame cascade shadow map include the depth value of the k^{th} pixel in the fusion map corresponding to the j^{th} shadow map of the i^{th}-frame cascade shadow map, the computer device determines a smaller value as the depth value of the k^{th} pixel in the fusion map corresponding to the j^{th} shadow map of the i^{th}-frame cascade shadow map.

For example, assuming that the first map corresponding to the j^{th} shadow map of the i^{th}-frame cascade shadow map includes a depth value z1 of the k^{th} pixel in the fusion map corresponding to the j^{th} shadow map of the i^{th}-frame cascade shadow map; and the second map corresponding to the j^{th} shadow map of the i^{th}-frame cascade shadow map does not include the depth value of the k^{th} pixel in the fusion map corresponding to the j^{th} shadow map of the i^{th}-frame cascade shadow map, the depth value of the k^{th} pixel in the fusion map corresponding to the j^{th} shadow map of the i^{th}-frame cascade shadow map is determined as z1. Similarly, assuming that the first map corresponding to the j^{th} shadow map of the i^{th}-frame cascade shadow map does not include a depth value of the k^{th} pixel in the fusion map corresponding to the j^{th} shadow map of the i^{th}-frame cascade shadow map; and the second map corresponding to the j^{th} shadow map of the i^{th}-frame cascade shadow map includes a depth value z2 of the k^{th} pixel in the fusion map corresponding to the j^{th} shadow map of the i^{th}-frame cascade shadow map, the depth value of the k^{th} pixel in the fusion map corresponding to the j^{th} shadow map of the i^{th}-frame cascade shadow map is determined as z2. Assuming that the first map corresponding to the j^{th} shadow map of the i^{th}-frame cascade shadow map includes the depth value z1 of the k^{th} pixel in the fusion map corresponding to the j^{th} shadow map of the i^{th}-frame cascade shadow map; and the second map corresponding to the j^{th} shadow map of the i^{th}-frame cascade shadow map includes the depth value z2 of the k^{th} pixel in the fusion map corresponding to the j^{th} shadow map of the i^{th}-frame cascade shadow map, if z1 is greater or equal to z2, the depth value of the k^{th} pixel in the fusion map corresponding to the j^{th} shadow map of the i^{th}-frame cascade shadow map is determined as z2; and if z1 is smaller than z2, the depth value of the k^{th} pixel in the fusion map corresponding to the j^{th} shadow map of the i^{th}-frame cascade shadow map is determined as z1.

Further, the computer device filters the M fusion maps, to obtain M filtered fusion maps. The filtering is configured for filling in a depth value of a target pixel (neither the first map corresponding to the j^{th} shadow map of the i^{th}-frame cascade shadow map nor the second map corresponding to the j^{th} shadow map of the i^{th}-frame cascade shadow map includes the depth value of the target pixel) in the fusion map corresponding to the j^{th} shadow map of the i^{th}-frame cascade shadow map. For example, the computer device obtains depth values of neighboring pixels of the target pixel from the fusion map corresponding to the j^{th} shadow map of the i^{th}-frame cascade shadow map, and predicts the depth value of the target pixel based on the depth values of the neighboring pixels of the target pixel. The neighboring pixels of the target pixel may refer to pixels located around the target pixel within a preset step size (for example, 2). FIG. 4b is a schematic diagram of neighboring pixels of a target pixel according to an aspect of this disclosure. As shown in FIG. 4b, when the preset step size is 2, neighboring pixels of a target pixel A3B3 are A1B1 to A1B5, A2B1 to A2B5, A3B1, A3B2, A3B4, A3B5, A4B1 to A4B5, and A5B1 to A5B5.

In some aspects, the neighboring pixels of the target pixel may alternatively refer to pixels that are closest to the target pixel in four directions of up, down, left and right directions of the target pixel and that carry depth values. FIG. 4c is a schematic diagram of neighboring pixels of another target pixel according to an aspect of this disclosure. As shown in FIG. 4c, neighboring pixels of a target pixel A3B3 are A2B3, A3B1, A3B4, and A5B3. Depth values of pixels in FIG. 4b and FIG. 4c are merely used as an example, and do not constitute an actual limitation of this disclosure.

It is set that a quantity of the neighboring pixels of the target pixel is Q, where Q is an integer greater than 1. In an aspect, the computer device determines an intermediate value or a smallest value of the depth values of the Q neighboring pixels as the depth value of the target pixel. Using FIG. 4b as an example, the computer device sorts depth values of all pixels in FIG. 4b in ascending or descending order, to obtain that an intermediate value of the depth values of all the pixels in FIG. 4b is 16, and then the computer device replaces the depth value of the target pixel with 16. Using FIG. 4c as an example, the depth values of the neighboring pixels of the target pixel are respectively: 6, 7, 16, and 20. Then, the computer device sets the depth value of the target pixel to 6.

In an implementation, the computer device first groups pixels in the fusion map, where each group of pixels include P×P pixels, and P is an integer greater than 1. In an aspect, the computer device allocates (for example, by using a compute shader) a thread to each pixel in the group, to read a depth value of the pixel (in the shadow space). The depth value read by each thread is stored (for example, stored into a group shared memory, and a group memory barrier with group sync function is called to synchronize data stored into the group shared memory). In another aspect, the computer device calls one or more threads in each pixel group to read depth values of neighboring pixels of the pixel group. In addition, the depth value read by each thread is stored (for example, stored into a group shared memory, and a group memory barrier with group sync function is called to synchronize data stored into the group shared memory). Then, the computer device predicts the pixel through the depth values of the neighboring pixels of one or more pixels in the pixel group, to obtain a filtered fusion map.

For example, it is assumed that 16×16 pixels are used as one group, the computer device allocates 256 threads for the group, and it is set that the preset step size is 2. In this case, for one pixel group, a scale including the pixel group and the neighboring pixels of the pixel group is 20×20. The computer device may call R (R is greater than or equal to 1, and less than or equal to 144) threads in the allocated 256 threads to read the depth values of the neighboring pixels of the pixel group, and predict the pixel through the depth values of the neighboring pixels of one or more pixels in the pixel group, to obtain the filtered fusion map.

In another aspect, the computer device determines an average value of the depth values of the Q neighboring pixels as the depth value of the target pixel. In still another aspect, the computer device performs prediction processing on the depth values of the Q neighboring pixels through a prediction model, to obtain the depth value of the target pixel. In some aspects, the foregoing aspect of filtering the target pixel may be applied to another pixel in the fusion map (for example, a pixel carrying a depth value in the fusion map, that is, a depth value of the pixel carrying the depth value in the fusion map is updated through the foregoing filtering method). This is not limited in this disclosure.

Since the depth values of the neighboring pixels can reflect, at an overall level, a depth value of an area in which the neighboring pixels are located, the depth value of the target pixel can be predicted more accurately through the depth values of the neighboring pixels, thereby improving integrity of the depth values of the pixels in the fusion map.

Based on the aspect of step S302 to step S310, the computer device may obtain M filtered fusion maps, and update M shadow maps of the i^{th}-frame cascade shadow map through the M filtered fusion maps (for example, replace the M shadow maps of the i^{th}-frame cascade shadow map with the corresponding M filtered fusion maps), to obtain an updated (i+1)^{th}-frame cascade shadow map.

It is proved in practice that, in comparison with a conventional framed shadow map solution, through the image processing method provided in this disclosure (that is, a manner of reconstructing the shadow map in the (i+1)^{th}-frame cascade shadow map by re-projecting the shadow map in the i^{th}-frame cascade shadow map and (the position of) the pixel in the i^{th} picture frame), picture shadow quality and fluency can be greatly improved when lamp light (a light source in a scene) changes, and characteristics of low time consumption and bandwidth of the conventional framed shadow map are reserved.

S311. Render each pixel in the (i+1)^{th} picture frame through the (i+1)^{th}-frame cascade shadow map, to obtain the (i+1)^{th} picture frame. For example, the (i+1)^{th} image frame is rendered based on shadow space depth values of the pixels with depth values for corresponding positions in the (i+1)^{th}-frame cascaded shadow map.

In an implementation, in one aspect, the computer device obtains the view projection matrix (of the capture device) corresponding to the (i+1)^{th} picture frame and the shadow projection matrix of the j^{th} shadow map of the (i+1)^{th}-frame cascade shadow map. In another aspect, the computer device determines the position of each pixel in the (i+1)^{th} picture frame in the view space based on the position that is of each pixel in the (i+1)^{th} picture frame and that is in the (i+1)^{th} picture frame and the depth buffer information of the (i+1)^{th} picture frame.

Further, the computer device performs the third conversion on the position of each pixel in the (i+1)^{th} picture frame in the view space through the view projection matrix, to obtain the position of each pixel in the (i+1)^{th} picture frame in the world space; and then, performs the second conversion on the position of each pixel in the (i+1)^{th} picture frame in the world space through the shadow projection matrix of the j^{th} shadow map of the (i+1)^{th}-frame cascade shadow map, to obtain the position of each pixel in the (i+1)^{th} picture frame in the shadow space. After obtaining the position of each pixel in the (i+1)^{th} picture frame in the shadow space, the computer device renders each pixel in the (i+1)^{th} picture frame based on the position of each pixel in the (i+1)^{th} picture frame in the shadow space and the (i+1)^{th}-frame cascade shadow map, to obtain the (i+1)^{th} picture frame.

In an aspect, the computer device determines the map position and the depth value of the k^{th} pixel in the (i+1)^{th} picture frame based on the position of the k^{th} pixel in the shadow space. If the depth value of the k^{th} pixel is greater than the depth value of the target pixel in the (i+1)^{th}-frame cascade shadow map, the computer device determines the k^{th} pixel as a shadow area pixel. If the depth value of the k^{th} pixel is less than or equal to the depth value of the target pixel in the (i+1)^{th}-frame cascade shadow map, the computer device determines the k^{th} pixel as a non-shadow area pixel. A position of the target pixel in the j^{th} shadow map of the (i+1)^{th}-frame cascade shadow map matches the map position of the k^{th} pixel.

Pixels in the (i+1)^{th} picture frame that belong to the shadow area and pixels in the (i+1)^{th} picture frame that belong to the non-shadow area can be quickly determined through a difference between the depth value of the pixel in the (i+1)^{th} picture frame and a depth value of a matched pixel in the (i+1)^{th}-frame cascade shadow map, thereby effectively improving rendering efficiency of the (i+1)^{th} picture frame, and obtaining a better shadow rendering effect.

In an implementation, the picture frame may be a picture frame of a virtual scene. For example, the picture frame may be a virtual flight picture frame of an aircraft (such as an uncrewed aerial vehicle or a plane) or a virtual terrain detection picture frame of a movable platform (such as an underwater robot or a mountain detection device). In one aspect, the computer device obtains an i^{th}-frame cascade shadow map of a virtual scene, and performs first re-projection processing on the i^{th}-frame cascade shadow map, to obtain M first maps. In another aspect, the computer device obtains depth buffer information of the (i+1)^{th} picture frame, determines a position of each pixel in the (i+1)^{th} picture frame in the view space based on the depth buffer information of the (i+1)^{th} picture frame, and then, performs second re-projection processing on the position of each pixel in the (i+1)^{th} virtual scene picture frame in the view space, to obtain M second maps corresponding to the M first maps. After obtaining the M first maps and the M second maps, the computer device updates M shadow maps in the i^{th}-frame cascade shadow map based on the M first maps and the M second maps, to obtain an (i+1)^{th}-frame cascade shadow map; and renders an (i+1)^{th} picture frame of the virtual scene through the (i+1)^{th}-frame cascade shadow map. In view of the above, through the aspect, a picture frame of the virtual scene can be simulated (for example, a flight picture frame of an aircraft is simulated), and a restoration degree (fidelity) of the picture frame of the virtual scene can be improved.

In another aspect, the picture frame may be an animation frame in an animation. For example, the picture frame may be an animation frame in a three-dimensional game animation. In one aspect, the computer device obtains an i^{th}-frame cascade shadow map of the three-dimensional game animation, and performs the first re-projection processing on the i^{th}-frame cascade shadow map of the three-dimensional game animation, to obtain M first maps. In another aspect, the computer device obtains depth buffer information of an (i+1)^{th} animation frame, determines a position of each pixel in the (i+1)^{th} animation frame in the view space based on the depth buffer information of the (i+1)^{th} animation frame, and then, performs the second re-projection processing on the position of each pixel in the (i+1)^{th} animation frame in the view space, to obtain M second maps corresponding to the M first maps. After obtaining the M first maps and the M second maps, the computer device updates M shadow maps in the i^{th}-frame cascade shadow map based on the M first maps and the M second maps, to obtain an (i+1)^{th}-frame cascade shadow map; and renders the (i+1)^{th} animation frame of the three-dimensional game animation through the (i+1)^{th}-frame cascade shadow map. In view of the above, through the aspect, the three-dimensional game animation can be rendered, and a speed of rendering a game animation frame can be improved by reducing computing resources required for rendering the game animation frame, thereby improving smoothness of a three-dimensional game and improving a restoration degree (fidelity) of the three-dimensional game animation.

In another aspect, the picture frame may be a point cloud frame. In one aspect, the computer device obtains an i^{th}-frame cascade shadow map, and performs the first re-projection processing on the i^{th}-frame cascade shadow map, to obtain M first maps. In another aspect, the computer device obtains depth buffer information of an (i+1)^{th} point cloud frame, determines a position of each pixel in the (i+1)^{th} point cloud frame in the view space based on the depth buffer information of the (i+1)^{th} point cloud frame, and then, performs the second re-projection processing on the position of each pixel in the (i+1)^{th} picture frame in the view space, to obtain M second maps corresponding to the M first maps. After obtaining the M first maps and the M second maps, the computer device updates M shadow maps in the i^{th}-frame cascade shadow map based on the M first maps and the M second maps, to obtain an (i+1)^{th}-frame cascade shadow map; and renders the (i+1)^{th} point cloud frame through the (i+1)^{th}-frame cascade shadow map. In view of the above, through the aspect, the point cloud frame can be rendered, thereby effectively reducing computing resources required for rendering the point cloud frame, and improving a restoration degree (fidelity) of the point cloud frame.

According to an aspect of this disclosure, an i^{th}-frame cascade shadow map is obtained; first re-projection processing is performed on M shadow maps of the i^{th}-frame cascade shadow map, to obtain M first maps; depth buffer information of each pixel in an (i+1)^{th} picture frame is obtained, and second re-projection processing is performed on the pixel in the (i+1)^{th} picture frame based on the depth buffer information, to obtain M second maps; and the M shadow maps are updated based on the M first maps and the M second maps, to obtain an (i+1)^{th}-frame cascade shadow map. In view of the above, the M shadow maps are updated based on a re-projection result of the M shadow maps of the i^{th}-frame cascade shadow map and a re-projection result of the depth buffer information of the (i+1)^{th} picture frame, to obtain the (i+1)^{th}-frame cascade shadow map, thereby reducing computing resources required for updating a cascade shadow map. Further, the (i+1)^{th} picture frame is rendered by using an updated (i+1)^{th}-frame cascade shadow map, to improve a rendering effect of the picture frame. In addition, in a process of updating the M shadow maps based on the M fusion maps (obtained by fusing the M first maps and the M second maps), one or more pixels in the fusion map are filtered, to improve smoothness of the fusion map, thereby improving quality of the (i+1)^{th}-frame cascade shadow map.

The methods in the aspects of this disclosure are described in detail above. For ease of better implementing the foregoing solutions in the aspects of this disclosure, an apparatus In an implementation of this disclosure is correspondingly provided below.

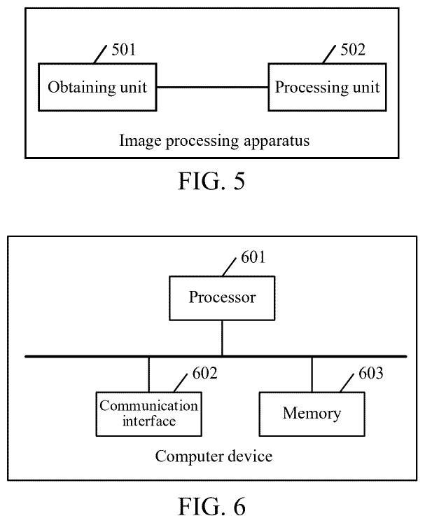

FIG. 5 is a schematic structural diagram of an image processing apparatus according to an aspect of this disclosure. The image processing apparatus shown in FIG. 5 may be installed in a computer device. The computer device may be a terminal device or a server. The image processing apparatus shown in FIG. 5 may be configured to perform some or all of the functions in the method aspects described in FIG. 2 and FIG. 3. Refer to FIG. 5. The image processing apparatus includes:

an obtaining unit 501, configured to obtain an i^{th}-frame cascade shadow map, the i^{th}-frame cascade shadow map being configured for rendering an i^{th} picture frame, and i being a positive integer; and

a processing unit 502, configured to perform re-projection processing on M shadow maps of the i^{th}-frame cascade shadow map, to obtain M first maps, M being a positive integer, where

the obtaining unit 501 is further configured to obtain depth buffer information of each pixel in an (i+1)^{th} picture frame; and

the processing unit 502 is further configured to: perform second re-projection processing on the pixel in the (i+1)^{th} picture frame based on the depth buffer information, to obtain M second maps; and

update the M shadow maps based on the M first maps and the M second maps, to obtain an (i+1)^{th}-frame cascade shadow map; and the (i+1)^{th}-frame cascade shadow map being configured for rendering the (i+1)^{th} picture frame.

In an implementation, each shadow map carries a depth value of each pixel in the shadow map; and a process in which the processing unit 502 performs first re-projection processing on M shadow maps of the i^{th}-frame cascade shadow map, to obtain M first maps includes:

obtaining a shadow projection matrix of a j^{th} shadow map of an (i+1)^{th}-frame cascade shadow map;

determining, based on a depth value of each pixel in a j^{th} shadow map of the i^{th}-frame cascade shadow map, a position of each pixel in the j^{th} shadow map of the i^{th}-frame cascade shadow map in shadow space;

updating, by using the shadow projection matrix of the j^{th} shadow map of the (i+1)^{th}-frame cascade shadow map, the position of each pixel in the j^{th} shadow map of the i^{th}-frame cascade shadow map in the shadow space; and

updating a to-be-updated map based on an updated position of each pixel in the j^{th} shadow map of the i^{th}-frame cascade shadow map in the shadow space, to obtain a first map corresponding to the j^{th} shadow map of the i^{th}-frame cascade shadow map, where the to-be-updated map is the j^{th} shadow map of the i^{th}-frame cascade shadow map, or a preset shadow map.

In an implementation, the processing unit 502 is configured to update, by using the shadow projection matrix of the j^{th} shadow map of the (i+1)^{th}-frame cascade shadow map, the position of each pixel in the j^{th} shadow map of the i^{th}-frame cascade shadow map in the shadow space, and the processing unit is configured to:

obtain an inverse shadow projection matrix of the j^{th} shadow map of the i^{th}-frame cascade shadow map;

perform, by using the inverse shadow projection matrix of the j^{th} shadow map of the i^{th}-frame cascade shadow map, first conversion on the position of each pixel in the j^{th} shadow map of the i^{th}-frame cascade shadow map in the shadow space, to obtain a position of each pixel in the j^{th} shadow map of the i^{th}-frame cascade shadow map in world space; and

perform, by using the shadow projection matrix of the j^{th} shadow map of the (i+1)^{th}-frame cascade shadow map, second conversion on the position of each pixel in the j^{th} shadow map of the i^{th}-frame cascade shadow map in the world space, to obtain an updated position of each pixel in the j^{th} shadow map of the i^{th}-frame cascade shadow map in the shadow space.

In an implementation, a process in which the processing unit 502 updates a to-be-updated map based on the updated position of each pixel in the j^{th} shadow map of the i^{th}-frame cascade shadow map in the shadow space, to obtain a first map corresponding to the j^{th} shadow map of the i^{th}-frame cascade shadow map includes:

determining, based on an updated position of a k^{th} pixel in the j^{th} shadow map of the i^{th}-frame cascade shadow map in the shadow space, a map position and a depth update value of the k^{th} pixel; and

if a depth value of a target pixel in the to-be-updated map is greater than the depth update value of the k^{th} pixel, updating the depth value of the target pixel to the depth update value of the k^{th} pixel, where

a position of the target pixel in the to-be-updated map matches the map position of the k^{th} pixel; and the k^{th} pixel in the j^{th} shadow map of the i^{th}-frame cascade shadow map is any pixel in the j^{th} shadow map of the i^{th}-frame cascade shadow map.

In an implementation, a process in which the processing unit 502 performs second re-projection processing on the pixel in the (i+1)^{th} picture frame based on the depth buffer information, to obtain M second maps includes:

obtaining a view projection matrix corresponding to the (i+1)^{th} picture frame, and the shadow projection matrix of the j^{th} shadow map of the (i+1)^{th}-frame cascade shadow map;

determining, based on a position that is of each pixel in the (i+1)^{th} picture frame and that is in the (i+1)^{th} picture frame and the depth buffer information, a position of each pixel in the (i+1)^{th} picture frame in view space;

converting, by using the view projection matrix corresponding to the (i+1)^{th} picture frame and the shadow projection matrix of the j^{th} shadow map of the (i+1)^{th}-frame cascade shadow map, the position of each pixel in the (i+1)^{th} picture frame in the view space into a position in the shadow space; and

updating the to-be-updated map based on a position that is of each pixel in the (i+1)^{th} picture frame and that is in the shadow space, to obtain a second map corresponding to the j^{th} shadow map of the i^{th}-frame cascade shadow map, where the to-be-updated map is the j^{th} shadow map of the i^{th}-frame cascade shadow map, or the preset shadow map.

In an implementation, the processing unit 502 is configured to convert, by using the view projection matrix corresponding to the (i+1)^{th} picture frame and the shadow projection matrix of the j^{th} shadow map of the (i+1)^{th}-frame cascade shadow map, the position of each pixel in the (i+1)^{th} picture frame in the view space into a position in the shadow space, and the processing unit is configured to:

perform, by using the view projection matrix, third conversion on the position of each pixel in the (i+1)^{th} picture frame in the view space, to obtain the position of each pixel in the (i+1)^{th} picture frame in the world space; and

perform, by using the shadow projection matrix of the j^{th} shadow map of the (i+1)^{th}-frame cascade shadow map, the second conversion on the position of each pixel in the (i+1)^{th} picture frame in the world space, to obtain the position of each pixel in the (i+1)^{th} picture frame in the shadow space.

In an implementation, a process in which the processing unit 502 updates the to-be-updated map based on the position of each pixel in the (i+1)^{th} picture frame in the shadow space, to obtain a second map corresponding to the j^{th} shadow map of the i^{th}-frame cascade shadow map includes:

determining, based on the position of the k^{th} pixel in the (i+1)^{th} picture frame in the shadow space, the map position and the depth value of the k^{th} pixel; and

if the depth value of the target pixel in the to-be-updated map is greater than the depth value of the k^{th} pixel, updating the depth value of the target pixel to the depth value of the k^{th} pixel, where

the position of the target pixel in the to-be-updated map matches the map position of the k^{th} pixel, and the k^{th} pixel in the (i+1)^{th} picture frame is any pixel in the (i+1)^{th} picture frame.

In an implementation, the processing unit 502 is configured to update the M shadow maps based on the M first maps and the M second maps, to obtain the (i+1)^{th}-frame cascade shadow map, and the processing unit is configured to:

fuse each first map with a second map corresponding to the first map, to obtain M fusion maps;

filter the M fusion maps, to obtain M filtered fusion maps; and

updating, by using the M filtered fusion maps, M shadow maps of the i^{th}-frame cascade shadow map, to obtain an updated (i+1)^{th}-frame cascade shadow map.

In an implementation, a process in which the processing unit 502 filters the M fusion maps, to obtain the M filtered fusion maps includes:

obtaining, from a fusion map corresponding to the j^{th} shadow map of the i^{th}-frame cascade shadow map, depth values of neighboring pixels of the target pixel, where the depth value of the target pixel is not included in the first map and the second map corresponding to the j^{th} shadow map of the i^{th}-frame cascade shadow map; and

predicting the depth value of the target pixel based on the depth values of the neighboring pixels of the target pixel

In an implementation, a quantity of the neighboring pixels of the target pixel is Q, where Q is an integer greater than 1; and the processing unit 502 is configured to predict the depth value of the target pixel based on the depth values of the neighboring pixels of the target pixel, and the processing unit is configured to:

determine an intermediate value or a smallest value of the depth values of the Q neighboring pixels as the depth value of the target pixel; or

determine an average value of the depth values of the Q neighboring pixels as the depth value of the target pixel; or

perform, by using a prediction model, prediction processing on the depth values of the Q neighboring pixels, to obtain the depth value of the target pixel.

In an implementation, the processing unit 502 is further configured to:

obtain a view projection matrix corresponding to the (i+1)^{th} picture frame, and the shadow projection matrix of the j^{th} shadow map of the (i+1)^{th}-frame cascade shadow map;

determine, based on the position that is of each pixel in the (i+1)^{th} picture frame and that is in the (i+1)^{th} picture frame and the depth buffer information, the position of each pixel in the (i+1)^{th} picture frame in the view space;

perform, by using the view projection matrix, the third conversion on the position of each pixel in the (i+1)^{th} picture frame in the view space, to obtain the position of each pixel in the (i+1)^{th} picture frame in the world space;

perform, by using the shadow projection matrix of the j^{th} shadow map of the (i+1)^{th}-frame cascade shadow map, the second conversion on the position of each pixel in the (i+1)^{th} picture frame in the world space, to obtain the position of each pixel in the (i+1)^{th} picture frame in the shadow space; and

render, based on the position of each pixel in the (i+1)^{th} picture frame in the shadow space and the (i+1)^{th}-frame cascade shadow map, each pixel in the (i+1)^{th} picture frame, to obtain the (i+1)^{th} picture frame.

In an implementation, a process in which the processing unit 502 renders, based on the position of each pixel in the (i+1)^{th} picture frame in the shadow space and the (i+1)^{th}-frame cascade shadow map, each pixel in the (i+1)^{th} picture frame, to obtain the (i+1)^{th} picture frame includes:

determining, based on the position of the k^{th} pixel in the (i+1)^{th} picture frame in the shadow space, the map position and the depth value of the k^{th} pixel;

determining the k^{th} pixel as a shadow area pixel if the depth value of the k^{th} pixel is greater than a depth value of a target pixel in the (i+1)^{th}-frame cascade shadow map; and

determining the k^{th} pixel as a non-shadow area pixel if the depth value of the k^{th} pixel is less than or equal to the depth value of the target pixel in the (i+1)^{th}-frame cascade shadow map, where

a position of the target pixel in the j^{th} shadow map of the (i+1)^{th}-frame cascade shadow map matches the map position of the k^{th} pixel.

According to an aspect of this disclosure, some operations in the image processing methods shown in FIG. 2 and FIG. 3 may be performed by the units in the image processing apparatus shown in FIG. 5. For example, operation S201 shown in FIG. 2 may be performed by the obtaining unit 501 shown in FIG. 5, operation S202 and operation S204 may be performed by the processing unit 502 shown in FIG. 5, and operation S203 may be cooperatively performed by the obtaining unit 501 and the processing unit 502 shown in FIG. 5. Operation S301, operation S302, and operation S306 shown in FIG. 3 may be performed by the obtaining unit 501 shown in FIG. 5, and operation S303 to operation S305 and operation S307 to operation S311 may be performed by the processing unit 502 shown in FIG. 5. The units in the image processing apparatus shown in FIG. 5 may be separately or entirely combined into one or several other units, or one (or more) of the units may be further divided into a plurality of units having smaller functions, which can implement the same operation without affecting the implementation of the technical effects of the aspects of this disclosure. The units are obtained through division based on logical functions. In actual applications, a function of one unit may be implemented by a plurality of units, or functions of a plurality of units may be implemented by one unit. In another aspect of this disclosure, the image processing apparatus may also include another unit. In actual applications, these functions may alternatively be cooperatively implemented by another unit and may be cooperatively implemented by a plurality of units.

According to another aspect of this disclosure, the image processing apparatus shown in FIG. 5 may be constructed and the image processing methods in the aspects of this disclosure may be implemented by running a computer program (including program code) that can be configured to perform the operations in the corresponding methods shown in FIG. 2 and FIG. 3 on a general-purpose computing apparatus, for example, a computer device, including processing elements and storage elements such as a central processing unit (CPU), a random access memory (RAM), and a read-only memory (ROM). The computer program may be recorded in, for example, a computer-readable recording medium, and may be loaded into the foregoing computing apparatus via the computer-readable recording medium and run in the computing apparatus.

Based on the same inventive concept, the principles and beneficial effects for resolving problems in the image processing apparatus provided in the aspects of this disclosure are similar to the principles and beneficial effects for resolving problems in the image processing method in the method aspects of this disclosure. Refer to the principles and beneficial effects of implementation of the method, and for brevity, details are not described herein again.

FIG. 6 is a schematic structural diagram of a computer device according to an aspect of this disclosure. The computer device may be a terminal device or a server. As shown in FIG. 6, the computer device includes processing circuitry, such as at least a processor 601, a communication interface 602, and a memory 603 (e.g., a non-transitory computer-readable storage medium). The processor 601, the communication interface 602, and the memory 603 may be connected through a bus or in another manner. The processor 601 (or referred to as a central processing unit (CPU)) is a computing core and a control core of the computer device. The processor may parse various instructions in the computer device and process various data of the computer device. For example, the CPU may be configured to parse power-on/off instructions transmitted by an object to the computer device, and control the computer device to perform a power-on/off operation. For another example, the CPU may perform transmission of various types of interaction data between internal structures of the computer device, and so on. In some aspects, the communication interface 602 may include a standard wired interface, a wireless interface (for example, a WI-FI or mobile communications interface), and may be controlled by the processor 601 to receive/transmit data; and the communication interface 602 may be further configured for data transmission and exchange within the computer device. The memory 603 is a memory component in the computer device, and is configured to store a program and data. The memory 603 herein may include both a memory built in the computer device and certainly may also include an extended memory supported by the computer device. The memory 603 provides storage space. The storage space stores an operating system of the computer device, which may include, but is not limited to, an Android system, an iOS system, a Windows Phone system, and the like. This is not limited in this disclosure.

An aspect of this disclosure further provides a computer-readable storage medium (memory), such as a non-transitory computer-readable storage medium. The computer-readable storage medium is a memory component in a computer device, and is configured to store a program and data. The computer-readable storage medium herein may include both a storage medium built in the computer device and certainly may also include an extended storage medium supported by the computer device. The computer-readable storage medium provides storage space storing a processing system of the computer device. In addition, the storage space further stores a computer program suitable for being loaded and executed by the processor 601. The computer-readable storage medium herein may be a high-speed RAM memory, or may be a non-volatile memory, for example, at least one magnetic disk memory. In some aspects, the computer-readable storage medium may be at least one computer-readable storage medium remotely located from the foregoing processor.

In an aspect, the processor 601 performs the following operations by running the computer program in the memory 603:
obtaining an i^{th}-frame cascade shadow map, the i^{th}-frame cascade shadow map being configured for rendering an i^{th} picture frame, and i being a positive integer;
performing first re-projection processing on M shadow maps of the i^{th}-frame cascade shadow map, to obtain M first maps, M being a positive integer;
obtaining depth buffer information of each pixel in an (i+1)^{th} picture frame, and performing second re-projection processing on the pixel in the (i+1)^{th} picture frame based on the depth buffer information, to obtain M second maps; and
updating the M shadow maps based on the M first maps and the M second maps, to obtain an (i+1)^{th}-frame cascade shadow map, the (i+1)^{th}-frame cascade shadow map being configured for rendering the (i+1)^{th} picture frame.

Based on the same inventive concept, the problem-resolving principle and beneficial effects of the computer device provided in this aspect of this disclosure are similar to those of the image processing method in the method aspects of this disclosure. Refer to the principle and beneficial effects of the implementation of the method. For brevity, details are not described herein again.

An aspect of this disclosure further provides a computer-readable storage medium, having a computer program stored therein, and the computer program being suitable for being loaded by a processor to perform the image processing methods according to the foregoing method aspects.

An aspect of this disclosure further provides a computer program product including a computer program. When the computer program product is run on a computer, the computer is enabled to perform the image processing methods provided in the foregoing aspects.

The operations of the methods in the aspects of this disclosure may be adjusted in terms of a sequence, combined, and deleted based on an actual requirement.

The modules of the apparatuses of the aspects of this disclosure may be combined, divided, or deleted according to an actual requirement.

Persons of ordinary skill in the art may understand that all or some of the steps of the methods in the foregoing aspects may be implemented by a program instructing relevant hardware. The program may be stored in a computer-readable storage medium. The readable storage medium may include: a flash disk, a read-only memory (ROM), a random access memory (RAM), a magnetic disk, or an optical disc.

One or more modules, submodules, and/or units of the apparatus can be implemented by processing circuitry, software, or a combination thereof, for example. The term module (and other similar terms such as unit, submodule, etc.) in this disclosure may refer to a software module, a hardware module, or a combination thereof. A software module (e.g., computer program) may be developed using a computer programming language and stored in memory or non-transitory computer-readable medium. The software module stored in the memory or medium is executable by a processor to thereby cause the processor to perform the operations of the module. A hardware module may be implemented using processing circuitry, including at least one processor and/or memory. Each hardware module can be implemented using one or more processors (or processors and memory). Likewise, a processor (or processors and memory) can be used to implement one or more hardware modules. Moreover, each module can be part of an overall module that includes the functionalities of the module. Modules can be combined, integrated, separated, and/or duplicated to support various applications. Also, a function being performed at a particular module can be performed at one or more other modules and/or by one or more other devices instead of or in addition to the function performed at the particular module. Further, modules can be implemented across multiple devices and/or other components local or remote to one another. Additionally, modules can be moved from one device and added to another device, and/or can be included in both devices.

The use of “at least one of” or “one of” in the disclosure is intended to include any one or a combination of the recited elements. For example, references to at least one of A, B, or C; at least one of A, B, and C; at least one of A, B, and/or C; and at least one of A to C are intended to include only A, only B, only C or any combination thereof. References to one of A or B and one of A and B are intended to include A or B or (A and B). The use of “one of”' does not preclude any combination of the recited elements when applicable, such as when the elements are not mutually exclusive.

The contents disclosed above are merely some examples of aspects of this disclosure and are not intended to limit the scope of this disclosure. Persons of ordinary skill in the art can understand all or a part of the procedures for implementing the foregoing aspects, and any equivalent variation made by them shall still fall within the scope of this disclosure.

What is claimed is:

1. An image processing method, comprising:
obtaining an i^{th}-frame cascaded shadow map to render an i^{th} image frame, i being a positive integer;
for each of M shadow map layers of the i^{th}-frame cascaded shadow map, performing a first reprojection to generate M first maps, each first map corresponding to a respective shadow map layer of the M shadow map layers, M being a positive integer;
obtaining depth buffer data for each pixel of an (i+1)^{th} image frame;
for each pixel of the (i+1)^{th} image frame, performing a second reprojection based on the depth buffer data to generate M second maps respectively corresponding to the M shadow map layers; and
updating the M shadow map layers based on the M first maps and the M second maps to obtain an (i+1)^{th}-frame cascaded shadow map to render the (i+1)^{th} image frame.

2. The method according to claim 1, wherein
each of the M shadow map layers includes a depth value for each pixel in the respective shadow map layer, and
the performing the first reprojection comprises:
obtaining a shadow projection matrix of a j^{th} shadow map layer of the (i+1)^{th}-frame cascaded shadow map, j being an integer and 1≤j≤M;
determining, from the depth values, pixel positions of the pixels in a shadow space of the j^{th} shadow map layer of the i^{th}-frame cascaded shadow map;
updating the pixel positions in the shadow space based on the shadow projection matrix; and
updating the j^{th} shadow map layer of the i^{th}-frame cascaded shadow map or a preset blank map with the updated pixel positions to form the first map corresponding to the j^{th} shadow map layer.

3. The method according to claim 2, wherein the updating the pixel positions comprises:
obtaining an inverse shadow projection matrix of the j^{th} shadow map layer of the i^{th}-frame cascaded shadow map;
converting the pixel positions in the shadow space to a virtual world space with the inverse shadow projection matrix; and
converting the pixel positions in the virtual world space to the shadow space with the shadow projection matrix of the j^{th} shadow map layer of the (i+1)^{th}-frame cascaded shadow map.

4. The method according to claim 2, wherein the updating the j^{th} shadow map layer of the i^{th}-frame cascaded shadow map or the preset blank map comprises:
determining, for each pixel k in the j^{th} shadow map layer of the i^{th}-frame cascaded shadow map, a map position and an updated depth value; and
when the depth value corresponding to the map position of pixel k is greater than the updated depth value, replacing the depth value with the updated depth value.

5. The method according to claim 1, wherein the performing the second reprojection comprises:
obtaining a view projection matrix for the (i+1)^{th} image frame and a shadow projection matrix of a j^{th} shadow map layer of the (i+1)^{th}-frame cascaded shadow map, j being an integer and 1≤j≤M;
converting pixel positions of the (i+1)^{th} image frame based on the depth buffer data to obtain view space positions;
converting the view space positions to shadow space positions based on the view projection matrix and the shadow projection matrix; and
updating the j^{th} shadow map layer of the i^{th}-frame cascaded shadow map or a preset blank map with the shadow space positions to form the second map corresponding to the j^{th} shadow map layer.

6. The method according to claim 5, wherein the converting the view space positions to the shadow space positions comprises:
converting the view space positions to virtual world space positions based on the view projection matrix; and
converting the virtual world space positions to the shadow space positions based on the shadow projection matrix.

7. The method according to claim 5, wherein the updating the j^{th} shadow map layer of the i^{th}-frame cascaded shadow map or the preset blank map comprises:
determining, for each pixel k in the (i+1)^{th} image frame, a map position and a depth value; and
when the depth value corresponding to the determined map position is greater than the depth value of the pixel k, replacing the depth value with the depth value of pixel k.

8. The method according to claim 1, wherein the updating the M shadow map layers comprises:
fusing each of the first maps with a corresponding one of the second maps to obtain M fusion maps respectively corresponding to the M shadow map layers;
filtering the M fusion maps to obtain M filtered fusion maps; and
updating the M shadow map layers of the i^{th}-frame cascaded shadow map based on the M filtered fusion maps to obtain the (i+1)^{th}-frame cascaded shadow map.

9. The method according to claim 8, wherein the filtering comprises:
for a target pixel without a depth value in the fused map corresponding to a j^{th} shadow map layer, j being an integer and 1≤j≤M, obtaining depth values of Q neighboring pixels, Q being an integer greater than 1; and
predicting the depth value of the target pixel based on the neighboring pixel depth values.

10. The method according to claim 9, wherein the predicting includes selecting one of:
an intermediate value or minimum depth value of the Q neighboring pixels;
an average depth value of the Q neighboring pixels; and
a depth value output based on a prediction model that processes the Q neighboring pixel depth values.

11. The method according to claim 1, further comprising:
obtaining a view projection matrix of the (i+1)^{th} image frame and a shadow projection matrix of a j^{th} shadow map layer of the (i+1)^{th}-frame cascaded shadow map, j being an integer and 1≤j≤M;
determining, based on the depth buffer data, view space positions of pixels in the (i+1)^{th} image frame;
converting the view space positions to virtual world space positions based on an inverse of the view projection matrix;
converting the virtual world space positions to shadow space positions based on the shadow projection matrix of the j^{th} shadow map layer; and
rendering the (i+1)^{th} image frame based on shadow space depth values of the pixels with depth values for corresponding positions in the (i+1)^{th}-frame cascaded shadow map.

12. The method according to claim 11, wherein the rendering comprises:
determining a pixel of the (i+1)^{th} image frame as a shadow area pixel when the depth value of the pixel is greater than a depth value corresponding to a map position matching a map position of the pixel in the (i+1)^{th}-frame cascaded shadow map; and
determining the pixel as a non-shadow area pixel when the depth value of the pixel is less than or equal to the depth value corresponding to the matching map position.

13. An image processing apparatus, comprising:
processing circuitry configured to:
obtain an i^{th}-frame cascaded shadow map to render an i^{th} image frame, i being a positive integer;
for each of M shadow map layers of the i^{th}-frame cascaded shadow map, perform a first reprojection to generate M first maps, each first map corresponding to a respective shadow map layer of the M shadow map layers, M being a positive integer;
obtain depth buffer data for each pixel of an (i+1)^{th} image frame;
for each pixel of the (i+1)^{th} image frame, perform a second reprojection based on the depth buffer data to generate M second maps respectively corresponding to the M shadow map layers; and
update the M shadow map layers based on the M first maps and the M second maps to obtain an (i+1)^{th}-frame cascaded shadow map to render the (i+1)^{th} image frame.

14. The apparatus according to claim 13, wherein
each of the M shadow map layers includes a depth value for each pixel in the respective shadow map layer, and
the processing circuitry is configured to:
obtain a shadow projection matrix of a j^{th} shadow map layer of the (i+1)^{th}-frame cascaded shadow map, j being an integer and 1≤j≤M;
determine, from the depth values, pixel positions of the pixels in a shadow space of the j^{th} shadow map layer of the i^{th}-frame cascaded shadow map;
update the pixel positions in the shadow space based on the shadow projection matrix; and
update the j^{th} shadow map layer of the i^{th}-frame cascaded shadow map or a preset blank map with the updated pixel positions to form the first map corresponding to the j^{th} shadow map layer.

15. The apparatus according to claim 14, wherein the processing circuitry is configured to:
obtain an inverse shadow projection matrix of the j^{th} shadow map layer of the i^{th}-frame cascaded shadow map;
convert the pixel positions in the shadow space to a virtual world space with the inverse shadow projection matrix; and
convert the pixel positions in the virtual world space to the shadow space with the shadow projection matrix of the j^{th} shadow map layer of the (i+1)^{th}-frame cascaded shadow map.

16. The apparatus according to claim 14, wherein the processing circuitry is configured to:
determine, for each pixel k in the j^{th} shadow map layer of the i^{th}-frame cascaded shadow map, a map position and an updated depth value; and
when the depth value corresponding to the map position of pixel k is greater than the updated depth value, replace the depth value with the updated depth value.

17. The apparatus according to claim 13, wherein the processing circuitry is configured to:
obtain a view projection matrix for the (i+1)^{th} image frame and a shadow projection matrix of a j^{th} shadow map layer of the (i+1)^{th}-frame cascaded shadow map, j being an integer and 1≤j≤M;
convert pixel positions of the (i+1)^{th} image frame based on the depth buffer data to obtain view space positions;
convert the view space positions to shadow space positions based on the view projection matrix and the shadow projection matrix; and
update the j^{th} shadow map layer of the i^{th}-frame cascaded shadow map or a preset blank map with the shadow space positions to form the second map corresponding to the j^{th} shadow map layer.

18. The apparatus according to claim 17, wherein the processing circuitry is configured to:
convert the view space positions to virtual world space positions based on the view projection matrix; and
convert the virtual world space positions to the shadow space positions based on the shadow projection matrix.

19. The apparatus according to claim 17, wherein the processing circuitry is configured to:
determine, for each pixel k in the (i+1)^{th} image frame, a map position and a depth value; and
when the depth value corresponding to the determined map position is greater than the depth value of the pixel k, replace the depth value with the depth value of pixel k.

20. A non-transitory computer-readable storage medium storing instructions which, when executed by a processor, cause the processor to perform:
obtaining an i^{th}-frame cascaded shadow map to render an i^{th} image frame, i being a positive integer;
for each of M shadow map layers of the i^{th}-frame cascaded shadow map, performing a first reprojection to generate M first maps, each first map corresponding to a respective shadow map layer of the M shadow map layers, M being a positive integer;
obtaining depth buffer data for each pixel of an (i+1)^{th} image frame;
for each pixel of the (i+1)^{th} image frame, performing a second reprojection based on the depth buffer data to generate M second maps respectively corresponding to the M shadow map layers; and
updating the M shadow map layers based on the M first maps and the M second maps to obtain an (i+1)^{th}-frame cascaded shadow map to render the (i+1)^{th} image frame.
